(19) United States
(12) Patent Application Publication
(10) Pub. No.: US 2026/0365488 A1
(43) Pub. Date: Nov. 19, 2026

(54) ELEVATOR, METHOD FOR INSTALLING ELEVATOR, BUILDING HAVING ELEVATOR, AND METHOD FOR CONSTRUCTING BUILDING

(71) Applicant: HYUNDAI ELEVATOR CO., LTD, Chungcheongbuk-do (KR)

(72) Inventors: Tae Won Lee, Chungcheongbuk-do (KR); Sung Joon Bae, Chungcheongbuk-do (KR); Woo Sung Hwang, Chungcheongbuk-do (KR); Jae Kwang Yu, Chungcheongbuk-do (KR); Dong Hwan Oh, Chungcheongbuk-do (KR); Jae Gu Choi, Chungcheongbuk-do (KR)

(21) Appl. No.: 19/434,728

(22) Filed: Dec. 29, 2025

(30) Foreign Application Priority Data
May 15, 2025 (KR) 10-2025-0063122

(51) Int. Cl. B66B 19/00

(52) U.S. Cl. CPC B66B 19/002

(57) ABSTRACT

According to the present disclosure, a method for constructing a building may include providing a hoist way during building construction; during the provision of the hoist way, providing an opening, at the lowest end of the hoist way, connecting the interior of the hoist way and the exterior of the hoist way; and lifting the first elevator module by a first length.

### CROSS-REFERENCE TO RELATED APPLICATIONS

This application is based on and claims priority under 35 U.S.C. § 119 to Korean Patent Application No. 10-2025-0063122 filed on May 15, 2025, with the Korean Intellectual Property Office, the disclosure of which is incorporated by reference herein in its entirety.

### BACKGROUND

The present disclosure relates to an elevator, a method for installing an elevator, a building having an elevator, and a method for constructing a building.

Technological advancements related to elevators are occurring rapidly. Elevators are advancing in step with the trend toward high-speed operation, high efficiency, eco-friendliness, and smarter operation. One example of this technological advancement is the modular elevator. Unlike conventional elevators, the modular elevators are machine-room-less (MRL) elevators, with their drive, control, and safety systems assembled as individual modules within the hoist way. The modular elevators are manufactured in advance by modularizing components at the elevator factory. They can then be easily assembled on-site. This shortens construction period and is effective in safety management and cost reduction. Other examples include preemptive fault detection and smart control technologies utilizing artificial intelligence (AI) and/or the Internet of Things (IoT). Furthermore, attempts are being made to expand the technology into future means of transportation, such as urban air mobility (UAM), which the applicant is researching. Thus, elevators are expanding beyond their mere means of transportation within buildings, and are undergoing various technological expansions.

An example of the technology for the modular elevator is Application No. 10-2024-199353, filed by the applicant herein, entitled “Entrance Module, Modular Elevator Including Entrance Module, and Method for Assembling Entrance Module.” This technology introduces a technology for precision assembly of the platform module. Another technology is Application No. 10-2024-0081110, filed by the applicant herein, entitled “Method for Manufacturing a Modular Elevator.” This technology introduces a technology for precision assembly of the rails.

Despite being installed within a building, the elevators are often treated as a separate process from the building itself. Consequently, numerous inconsistencies arise on-site.

### SUMMARY

The prior art has the following technical problems.

First, the elevator installation process is complex and time-consuming. Specifically, conventionally, major elevator components, such as rails, doors, and cars of the elevator, were individually transported on-site and sequentially assembled. Consequently, installation of these heavy components relies on on-site workers or auxiliary equipment, resulting in long construction times and significant labor requirements.

Second, there is the difficulty of lifting elevator components within the hoist way. Specifically, when designing hoist ways, elevator components are often disposed into the hoist way by horizontal entry through the platform or internal lifting through the platform.

Third, there is a lack of coordination between construction companies and elevator manufacturers. Specifically, construction companies only construct the hoist ways, while elevator installation is a completely separate process.

Fourth, there is the problem of incompatibility with modular construction methods. Specifically, despite the trend toward modular buildings, elevator installation still relies on horizontal entry through the platform or internal lifting through the platform.

The following describes solutions to the technical problems. The first problem of the [technical problem] can be solved by providing a structure for elevator components on the hoist way wall. The second problem of the [technical problem] can be solved by providing a structure capable of introducing elevator components onto the hoist way. In this case, the elevator components may include elevator modules of a modular elevator. The third problem of the [technical problem] can be solved by providing a structure suitable for elevator installation during construction. For this purpose, construction companies and elevator manufacturers can cooperate with each other. The fourth problem of the [technical problem] can be solved by proposing an introduction structure and introduction method for modularized elevator modules corresponding to modular buildings.

The solution to the technical problem is described in more detail.

According to the present disclosure, a method for constructing a building may include providing a hoist way during building construction; during the provision of the hoist way, providing an opening, at the lowest end of the hoist way, connecting the interior of the hoist way and the exterior of the hoist way; and lifting the first elevator module by a first length.

A method for constructing a building may include introducing a second elevator module stacked in the hoist way through the opening; connecting the first elevator module and the second elevator module to provide a module connection body; and lifting the module connection body by the first length.

The opening may be provided at a position slightly higher than a lowest end of the hoist way.

The opening may be provided in the lowest platform at the lowest floor.

The opening may be provided larger than the open space of the platform.

The opening may be provided larger than the cross-section of the elevator module in the vertical direction.

Before connecting the first elevator module and the second elevator module, the first elevator module may be lowered by a second length, and the second length may be shorter than the first length.

Before connecting the first elevator module and the second elevator module, the second elevator module may be lifted by a second length, and the second length may be shorter than the first length.

After lifting the module connection body by the first length, introduction of another elevator module stacked in the hoist way through the opening and connection of the module connection body and the other elevator module to provide another module connection body may be repeatedly performed.

At least one of the first elevator modules and the second elevator module may be lifted by at least one of a lifter provided at the upper portion of the hoist way, a lift provided at the lowermost end of the hoist way, and a crane provided outside the building.

At least one of the first elevator modules, the second elevator module, and the module connection body may be lifted solely by the lifter.

At least one of the first elevator modules, the second elevator modules, and the module connection body may be lifted solely by the lift.

At least one of the first elevator modules, the second elevator modules, and the module connection body may be lifted by the lifter and the lift.

At least one of the first elevator modules, the second elevator modules, and the module connection body may be lifted by two or more lifts.

In order to guide the lifting action of the lift, a movable plate provided on the upper portion of the lift, and a guide frame having a member extending in the vertical direction to guide the operation of the movable plate in the vertical direction and the operation of the elevator module in the vertical direction are provided.

The method for constructing a building may further include a first hook provided on the first elevator module; and a second hook provided on the second elevator module and structured to be hooked onto the first hook.

The first hook and the second hook may be hooked to each other to connect the first elevator module and the second elevator module, and a worker can change the position of the second elevator module with respect to the first elevator module.

The method for constructing a building may further include a first guide member provided to the first elevator module, and a second guide member provided to the second elevator module and fastened to the first guide member.

By providing an elongated hole extending in one direction in one of the first guide member and the second guide member, and providing a hole in the other of the first guide member and the second guide member, the first guide member and the second guide member may be finally fastened after the first elevator module and the second elevator module are aligned after the temporary assembly.

After all necessary elevator modules have been introduced through the opening, in order to change the opening to the flatform, work reducing open size of the opening to a size and specification of the platform may be performed.

According to the present disclosure, a method for installing an elevator may include assembling at least one module as an elevator component providing an elevator at a production site of the elevator; providing an opening at the lowest end of a hoist way of the building during building construction, connecting the interior of the hoist way and the exterior of the hoist way; transporting a first module among the at least one module stacked in the hoist way and introducing the first module through the opening; lifting the first module and waiting for introduction of a new module; introducing a second module among the at least one module stacked in the hoist way through the opening; providing a module connection body by connecting the first module and the second module; and lifting the module connection body.

The module may be a hexahedral frame provided with bars of predetermined cross-sections extending in the vertical direction, in the front and rear direction, and in the left and right direction, each of which is fastened to one another.

At least one of a rail, a door, and a buffer may be assembled at the elevator production site in the frame.

The method for installing an elevator may further include a first hook provided on the first module to connect the first module and the second module; and a second hook provided on the second module and structured to be hooked onto the first hook.

The method for installing an elevator may further include a first guide member provided to the first module; and a second guide member provided to the second module and fastened to the first guide member.

The method for installing an elevator may further include an unidirectionally elongated hole provided in one of the first guide member and the second guide member; a hole provided in the other of the first guide member and the second guide member; and a fastening member fastening the elongated hole and the hole to each other.

The first guide member and the second guide member may be provided at each of the four corners of the module.

The fastening member may be finally fastened after the first guide member and the second guide member are temporarily assembled and the four corners are aligned.

A lift installed in a space from a lower end of the opening to a lower end of the hoist way may lift the first module and the second module.

Together with the lift, a lifter or crane may support the first module and the second module.

In a state where a plurality of lifts are provided, a first lift among the plurality of lifts is raised to support the first module, a second lift among the plurality of lifts may be lowered to lift the second module.

The present disclosure may have the following effects:

First, installation efficiency increases and on-site assembly work is reduced. Second, the lifting of elevator modules is simplified within the hoist way. Third, the introduction structure of the elevator module entry can be provided during building construction, making elevator construction easier. Fourth, application thereof in modular construction significantly accelerates building construction and elevator installation.

In addition, the effect thereof may be further added to the detailed description of the present disclosure.

### BRIEF DESCRIPTION OF THE DRAWINGS

FIG. 1(a)-1(b) are structural drawings illustrating a building and an elevator, where FIG. 1(a) illustrates an elevator provided in a building, and FIG. 1(b) illustrates an elevator in which elevator modules are stacked.

FIG. 2(a)-2(d) are drawings illustrating a method for installing an elevator during the construction of a building, with drawings from FIG. 2(a) to 2(d) illustrating the time-series order.

FIG. 3(a)-3(d) are drawings illustrating an example of the detailed configuration of FIG. 1(a)-1(b) as example 2.

FIG. 4(a)-4(d) are drawings illustrating the time-series order from a to d of a method for installing an elevator during the construction of a building as example 3.

FIG. 5 is a drawing illustrating a method for installing an elevator during construction of a building according to example 4.

FIG. 6 is a drawing illustrating a method for installing an elevator during construction of a building according to example 5.

FIG. 7 is a flowchart illustrating a method of constructing a building according to example 6.

FIG. 8 is a flowchart illustrating a method of constructing a building according to example 7.

FIG. 9 is a flowchart illustrating a method of constructing a building according to example 8.

FIG. 10 is a flowchart illustrating a method of constructing a building according to example 9.

FIG. 11 is a flowchart illustrating a method of constructing a building according to example 10.

### DETAILED DESCRIPTION OF THE EMBODIMENTS

Hereinafter, specific embodiments of the present disclosure will be described in detail with reference to the drawings. The idea of the present disclosure is not limited to the following embodiments. Those skilled in the art who understand the idea of the present disclosure can easily propose other embodiments within the same idea by adding, modifying, deleting, or adding elements. However, this also falls within the idea scope of the present disclosure.

The present disclosure may include a plurality of embodiments. A first element of a first embodiment among the plurality of embodiments may be included by adding or modifying elements of another embodiment. A first element of a first embodiment among the plurality of embodiments and a second element of a second embodiment among the plurality of embodiments may be combined to provide another embodiment not specified in the plurality of embodiments.

In the description of the drawings, regardless of the drawing number and symbol, identical or similar elements are given identical or similar reference numbers, and redundant descriptions thereof may be omitted.

The drawings are provided solely to facilitate understanding of embodiments of the present disclosure, and the technical ideas of the present disclosure are not limited by the attached drawings. It should be understood that all modifications, equivalents, or alternatives included within the idea and technical scope of the present disclosure are included.

In describing the embodiments of the present disclosure, a detailed description of a related known technology may be omitted if it is determined that the detailed description may obscure the gist of the embodiments disclosed in the present specification.

In describing embodiments of the present disclosure, specific examples of related known technologies may be included in the specification. In this case, the technical connection between the known technologies and the present disclosure may be included within the technical idea of the present disclosure.

In the present disclosure, terms including ordinal numbers, such as “first,” “second,” or the like, may be used to describe various elements, but the elements are not limited by the terms. The terms may be used to distinguish one element from other element.

When an element is referred to as being “connected” or “accessed” to another element, it should be understood that it may be directly connected or accessed to other element, but that there may be other elements in between. Conversely, when an element is referred to as being “directly connected” or “directly accessed” to another element, it should be understood that there are no other elements in between.

A singular expression may include a plural expression unless the context clearly indicates otherwise.

In the present disclosure, terms such as “comprises” or “has” are intended to indicate the presence of a feature, number, step, operation, element, component, or combination thereof described in the specification. Therefore, they do not exclude the possibility of the presence or addition of one or more other features, numbers, steps, operations, elements, components, or combinations thereof.

In the present disclosure, if the direction is indicated, a direction of gravity can be defined as a vertical direction. A direction perpendicular to the direction of gravity can be defined as a left and right direction. A direction perpendicular to both the vertical and left and right directions can be defined as the front and rear direction. The front and rear direction can be exemplified by the direction viewed by an observer.

In the present disclosure, the hoisting machine T may refer to a device that drives the movement of a completed elevator in the vertical direction. The lifter T1 may refer to a construction winch or dedicated lifter for raising or lowering modules within the hoist way during building construction. The construction winch and the dedicated lifter can be distinguished in terms of function and installation purpose.

### EXAMPLE 1

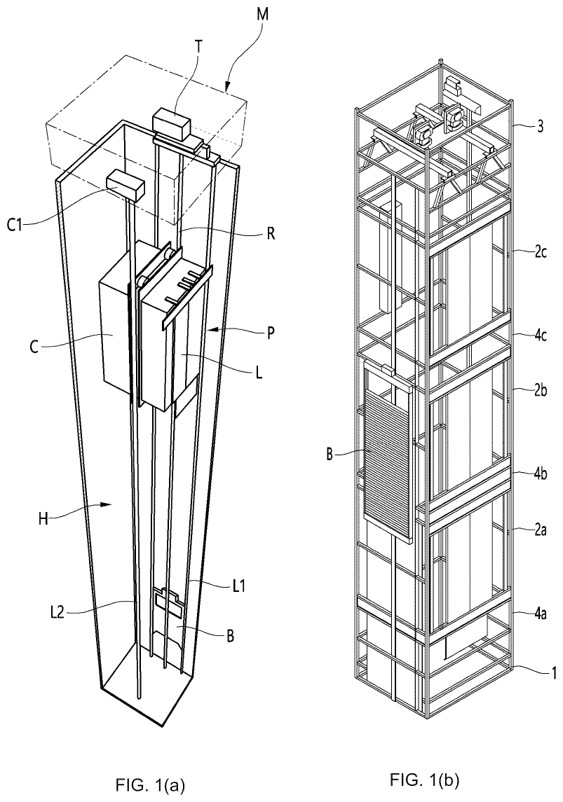

FIG. 1(a)-1(b) are structural drawings illustrating a building and an elevator, where FIG. 1(a) illustrates an elevator provided in a building, and FIG. 1(b) illustrates an elevator in which elevator modules are stacked. See FIG. 1(a)-1(b).

### Configuration and Operation of Elevator

An elevator can be installed in a building. Here, the building can be exemplified by a reinforced concrete structure, a steel structure, and a modular structure. The building can provide a platform and a hoist way to install the elevator. The platform and the hoist way can form a component of the elevator. The platform P can be exemplified by an entrance/exit space of each floor where the car C stops. A plurality of platforms can be provided in the building. The hoist way H can be exemplified by a passage through which the car C is raised and lowered. Components such as a traction machine T and a control module C1 that raise and lower the car C can be disposed on the upper end of the hoist way.

A door module L may be provided on the platform. The door module can be opened and closed in conjunction with the door of the car C. The traction machine T can rotate the rope R in both directions. The rope R can be wound around a sheave provided on the output side of the traction machine T. The rope R can extend in both directions with the traction machine as the geometric center. In other words, the rope R is supported by the sheave, and both ends thereof can extend downward by gravity.

The car C may be supported on the first side where the rope extends in one direction. A counterweight B (balance weight) may be supported on the second side where the rope extends in the other direction. The counterweight may compensate for the weight of the car C and the load loaded on the car. The counterweight may reduce energy consumption of the elevator, smoothen the operation of the elevator, and increase the stability of the system. Various methods for connecting the rope R, the car C, and the counterweight B may be provided according to the specifications, use, allowable load, and standards of the building and the elevator. Various methods for connecting the rope R, the car C, and the counterweight B may be included in the idea of the present disclosure.

According to the control of the control module C1, the traction machine T can be selectively driven. By moving the rope R wound around the sheave, the car C can move in the hoist way H in the vertical direction. By moving the rope R wound around the sheave, the car C and the counterweight B can move in the vertical direction. At this time, the car C and the counterweight B can move in opposite directions to each other. The vertical movement of the car C and the counterweight B can be guided by the first rail L1 and the second rail L2.

According to the control of the control module C1, the car C can stop at a specific location. The car C can stop corresponding to a specific platform P. The door of the car C and the door module L of the specific platform can be opened together.

Additional portions may be required for the configuration and operation of the elevator. For example, the counterweight B may also be provided with a sheave around which the rope R is wound. Even if each portion is not described in the present disclosure, the applicant declares that the portions necessary for the configuration and operation of the elevator are included in the present disclosure.

### Configuration and Operation of Rails L1 and L2

The rails L1 and L2 can be installed to extend vertically from the inner surface of the hoist way H. The rails L and L2 can be fastened to the inner surface of the hoist way H. The rails Land L2 can be directly fastened to the inner surface of the hoist way H using a single type of fastener or indirectly fastened using two or more types of fasteners. The rails Land L2 can guide the vertical movement of the car C and the counterweight B. The rails can prevent the car C and the counterweight B from swinging in the left and right direction and in the front and rear direction. The rails can have a plurality of sub-components connected vertically. The sub-components can refer to sub-components that form a component of the elevator. For example, a rail part of a predetermined length that provides a component as a single rail that is a component of the elevator can be referred to as a sub-component with respect to the single rail. The same applies hereinafter.

If the alignment of the sub-components is misaligned, problems such as vibration may occur during elevator operation. Furthermore, once the rail is fixed, it is difficult to adjust the alignment of the rail even if an error in the alignment of the rail is confirmed due to the amplified joint tolerance between a plurality of sub-components. As a technology to resolve this, the applicant's prior art application No. 10-2024-0081110, entitled “Method for Manufacturing a Modular Elevator,” discloses a fish plate, a clip member, and a fixing block for aligning. Precisely fixing the rail to the reference position can be said to be one of the core technologies in the field of elevator technology.

### Elevator Module

The modules of the elevator can be classified according to the height at which the modules are stacked in the hoist way. For example, the modules can include a lower end module 1 at the lowest floor. An intermediate module 2 can be stacked on top of the lower end module corresponding to each platform. The door module L can be installed corresponding to the intermediate module. At least two 2a, 2b, and 2c of the intermediate modules can be provided. An adapter module 4 that directly contacts the intermediate module can be provided on at least one of the upper end and the lower end of one of the intermediate modules. The adapter module 4 can be provided to adjust the vertical spacing between each module according to the specifications of the building. At least two 4a, 4b, and 4c of the adapter modules 4 can be provided as needed. An upper end module 3 can be stacked on the upper side of the highest intermediate module among the at least two intermediate modules.

The module may be provided by fastening bars having predetermined cross-sections extending in the vertical direction, in the front and rear direction, and in the left and right direction. The module may be provided as a hexahedral frame in which a plurality of the bars are connected. The cross-section of the bar may have at least one bent part. The cross-section of the bar may be provided as a square. The cross-section of the bar may be provided as a hollow square. The cross-section of the bar may be provided as a hollow square with one edge removed. The cross-section of the bar may be provided as a hollow square with two consecutive edges removed. The module may be fastened to the building or another adjacent module. Components of the elevator may be fixed and assembled to the frame. For example, rails, doors, buffers, or the like may be pre-assembled to the frame at the elevator production site.

Any one of the intermediate modules may be provided corresponding to any one of the platforms. In other words, one door module L may correspond to one intermediate module that is stacked. Of course, according to the specifications of the modules, one or more door modules may correspond to one intermediate module, or one or more intermediate modules may correspond to one door module. This may correspond to various specifications of the building. A pit module may be provided in the lower end module 1. The pit module may be disposed at the lowest end portion of the elevator, and a buffer and a sensor may be installed therein. The pit module may be directly disposed on the foundation structure during the construction of the building. A machine room module may be provided in the upper end module 3. The machine room module may provide a space for supporting a driving device. If the space is provided separately, it may be called a machine room (M). In the present embodiment, a separate machine room may not be provided. The traction machine T, the winch T1, electrical wiring, and control equipment may be supported therein. The upper end module 3 may be provided in two layers. A winch and a work plate may be provided on the lower layer of the two layers.

As a module of the elevator, a shaft module may be provided. The shaft module may provide a guide for a car to safely raise and lower by contacting the shaft module. The shaft module may include the rail and electrical wiring. At least one of the shaft module and the door module may be pre-fastened to the intermediate module. Here, the meaning of “pre-fastened” may mean that the module is fastened to the frame providing the module and moves together during movement.

As a module of the elevator, the control module C1 may be provided. In a narrow sense, the control module may refer to a control panel disposed in the machine room. In a broad sense, the control module C1 may include components such as a control panel, a communication device, an emergency backup power source, a remote monitoring system, a power line, a control line, and a safety circuit. The control module may also be disposed in other areas of the building other than the hoist way and the platform.

### Installation of Elevator Modules

The elevator modules can be installed during the construction of a building, or concurrently with the construction of the building. For example, the building construction may include foundation work to solidify the ground, framework construction to build the frame of a building, and finishing construction which finishes the interior and exterior of the framework. In the present disclosure, each module of the elevator can be stacked concurrently with the framework construction. The stacked elevator modules can provide an operable elevator.

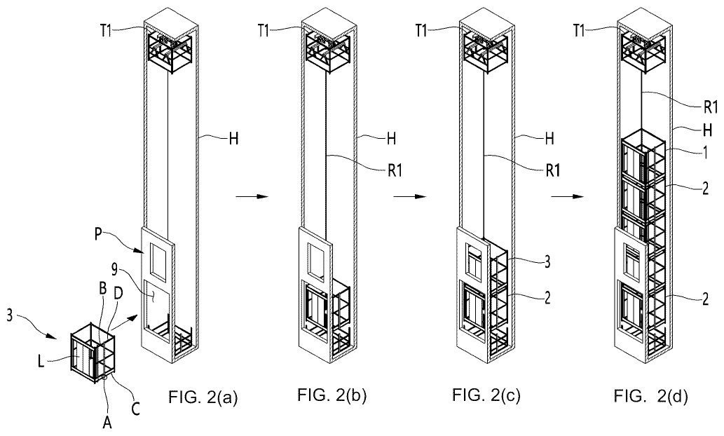

FIG. 2(a)-2(d) are drawings illustrating a method for installing an elevator during the construction of a building, with drawings from FIG. 2(a) to 2(d) illustrating the time-series order. See FIG. 2(a)-2(d).

Referring to (a), the building under construction may be provided with the hoist way H. The hoist way H may be provided with the platforms P for each floor of the building. An opening 9 may be provided at the lowest end of the hoist way. The interior and exterior of the hoist way may be connected through the opening. The opening may be provided at a position slightly higher than the lowest end of the hoist way. The opening 9 may provide the platform P of the lowest floor. The opening 9 may have a rectangular shape. The opening 9 may be provided larger than the open space of the platform P. The elevator module 1 may be introduced through the opening 9. The opening may be of a size into which the elevator module may be inserted. The opening may be provided larger than the cross-section of the elevator module in the vertical direction.

The floor height of the opening 9 can be provided at a height equal to or similar to the floor surface of the building or ground. This can facilitate introduction of the elevator module.

A lifter (for example, winch) T1 may be disposed at a high position (upper end or upper portion) of the hoist way H. The lifter may lift an elevator module 1, 2, 3, or 4 introduced through the opening 9. Here, the elevator module may include a component in which at least two elevator modules are combined.

Referring to (b), the lifter T1 and the elevator module 1 can be connected. A chain or rope can be used for the connection. The lifter can lift an elevator module by a predetermined length. Here, the predetermined length can correspond to the height of one elevator module. The predetermined length can correspond to the height of one floor of a building. The predetermined length can be slightly longer than the height of one elevator module.

Referring to (c), after the upper end module 1 as one elevator module is lifted to the predetermined length, the intermediate module 2 as another elevator module can be introduced. After the upper end module is lifted, the opening may be empty. Through this, the other elevator module can be introduced. Here, the one elevator module can be disposed on top of the other elevator module.

The other elevator module can be lifted by a predetermined length. In this case, the predetermined length to be lifted may be referred to as a second length, and the predetermined length to which the one elevator module is lifted may be referred to as a first length. The second length may be shorter than the first length. The first length may be a length necessary to empty the opening. This is because the second length is sufficient only to connect the two modules.

The one elevator module can be connected to the other elevator modules. Accordingly, the two members can be lifted together by the lifter. In this case, the two members can be lifted by a first length. It is not excluded that each line of the lifter lifts each elevator module. The lifter can lift at least two connected elevator modules together. the lifter can be used with two or more lifters.

The one elevator modules may be disposed on top of the other elevator module. At this time, the one elevator module may lower by a predetermined length. This predetermined length may be the second length. This allows the two modules to come into contact with each other in the vertical direction.

Referring to (d), the (a) to (c) can be repeated. Accordingly, all elevator modules 1, 2, 3, and 4 provided in the hoist way can be introduced. At this time, the elevator module can refer to all modules that are stacked vertically to provide an elevator. The elevator modules 1, 2, 3, and 4 can be disposed at corresponding positions on the hoist way.

Afterwards, finishing construction can be performed. The finishing construction can include at least one of fixing the elevator modules to the walls of the hoist way, firmly fixing the aligned elevator modules, and conducting a test run.

The opening 9 may be converted into a platform during the finishing construction. The finishing construction may include reducing the open size of the opening 9 to the size and specifications of the platform. An additional structure may be installed on the edge of the opening 9 to provide a platform.

### EXAMPLE 2

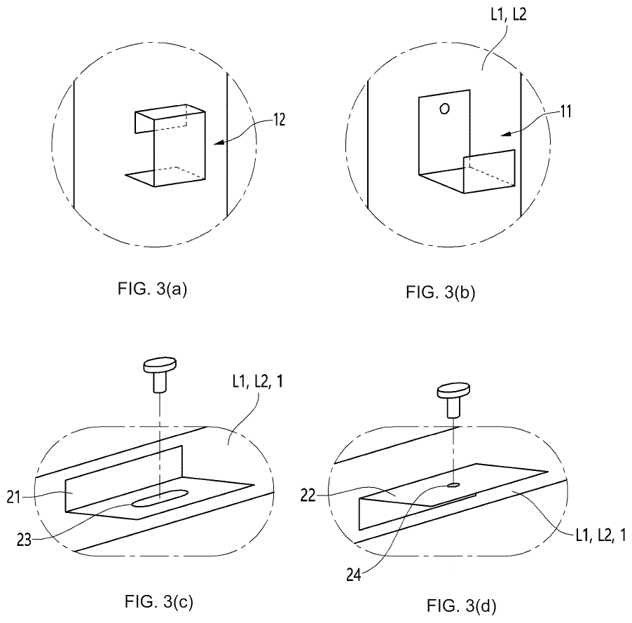

The example 2 is an example for interconnecting the elevator modules. The description of the example 1 may be applied to the description of the present example. FIG. 3(a)-3(d) are enlarged drawings of each portion of the elevator module of FIG. 1(a), where FIG. 3(a) is an enlarged view of A, FIG. 3(b) is an enlarged view of B, FIG. 3(c) is an enlarged view of C, and FIG. 3(d) is an enlarged view of D.

First, referring to FIG. 3(a)(b), the elevator module may be provided with a hook 11, 12. The hook may include a first hook 11 disposed at the lower portion of the elevator module, and a second hook 12 disposed at the upper portion of the elevator module. Here, the upper and lower portions may preferably be the upper and lower ends, respectively. The first and second hooks 11 and 12 may be hooked to each other. When the hooks are hooked, the connecting bodies of the elevator modules may support each other's weight. The hook is illustrated as a fixed type, but a movable hook capable of movement may also be applied.

The first and second hooks 11 and 12 may be provided on the rear surface (surface opposite to the car) of the rails L1 and L2. The hooks may be provided at any location on the frame (horizontal or vertical) forming the elevator module. The hooks may be provided at adjacent locations when two elevator modules are aligned in the vertical direction. The fastening between the hooks may be performed by manipulation when the lower elevator module is introduced. The hooks are illustrated as being provided at one corner of the elevator module, but may be provided together at two opposite corners. This can ensure balance. It is also possible for the hooks to be provided at all four corners.

The hooks can provide a degree of fastening force sufficient to support the weight of the lower elevator module. Even when the first and second hooks 11 and 12 are engaged, the two elevator modules can move relative to each other. While the hooks are engaged, the operator can change the position of the lower elevator module. The hooks can be used to temporarily assemble the elevator modules together.

Referring to FIG. 3(c)(d), the elevator module may be provided with guide members 21 and 22. The guide members 21 and 22 may include a first guide member 21 disposed on the lower portion of the elevator module, and a second guide member 22 disposed on the upper portion of the elevator module. Here, the upper portion and the lower portion may preferably be the upper end and the lower end, respectively. The guide members 21 and 22 may be fastened to each other. For this purpose, the two guide members may have contact surfaces. The guide members may have a contact surface and a fastening surface that is fastened to the elevator module. Here, the fastening surface may be fastened to any location of the frame (horizontal or vertical) forming the elevator module. The fastening surface may also be fastened to the rail.

With the hook engaged, the operator can change the positions of the two elevator modules. Accordingly, the opposing surfaces of the two contacting surfaces can move relative to each other. The guide members can be fastened to each other while the two elevator modules are aligned. To this end, an elongated hole 23 extending in one direction can be provided in the first guide member 21, and a hole (24) can be provided in the second guide member 22. A bolt can be fastened to the aligned position of the elongated hole and the hole. Even if the second guide member moves in the extension direction of the elongated hole, the guide members can be fastened to each other. In other words, the bolt can be fastened when the two elevator modules are aligned. At this time, the bolt can be finally fastened after the alignment of the guide members in other locations is also adjusted after the temporarily assembly.

The guide members 21 and 22 are illustrated as being provided at one corner of the elevator module, but may be provided at all four corners. Accordingly, alignment can be achieved in both the front and rear direction and the left and right direction.

### EXAMPLE 3

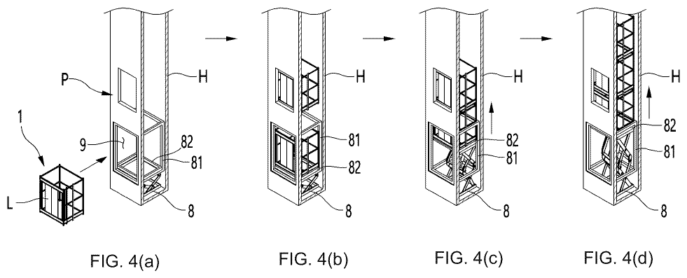

Example 3 is an example of lifting the elevator module in a building. The description of example 1 applies to the description of the present example, and the differences are explained. FIG. 4(a)-4(d) are drawings illustrating a method for installing an elevator during building construction, with lines a through d representing the time-series order.

Refer to FIG. 4(a). A lift 8 may be provided in the space from the lower end of the opening 9 to the lower end of the hoist way. The lift 8 is a device that lifts items disposed by power. A hydraulic lift using hydraulic pressure may be used as the lift. The elevator modules 1, 2, 3, and 4 may be introduced through the opening 9 and mounted on the upper surface of the lift 8. At this time, if there is another elevator module (first elevator module) in an upper portion of the currently introduced elevator module (second elevator module), the first elevator module may be maintained in position by the lifter T1. The first elevator module may not be a single module, but may be a connection body of the elevator module in which two or more elevator modules are connected.

A structure guiding the lifting by the lift may be provided in an upper portion of the lift 8. A movable plate 82 may be provided on the upper portion of the lift. The elevator module may be seated on the upper surface of the movable plate. The movable plate 82 may be moved by the lift 8 in the vertical direction. A guide frame 81 may be provided to guide at least one of the movement of the movable plate 82 in the vertical direction and the movement of the elevator module in the vertical direction. The guide frame may have a bar of a predetermined cross-section extending in the vertical direction. The guide frame may be provided in a hexahedron. At least one of the contact between the guide frame and the movable plate and the contact between the guide frame and the elevator module may be permitted. Accordingly, the lifting by the lift 8 may be performed smoothly.

Refer to FIG. 4(b). Lifting of the lift 8 can be performed. During the lifting process, the guiding function of the guide frame can be performed.

Referring to FIG. 4(c). The lifting of the elevator modules can be performed to a distance where the elevator module (second elevator module) comes into contact with or is adjacent to the other elevator module (first elevator module). The two elevator modules can be connected to each other to provide a connection body for the elevator modules. While the two elevator modules are being connected, the guide frame 81 can support the lower elevator module based on the connecting portion, and the lifter T1 can support the upper elevator module based on the connecting portion. Accordingly, there can be an advantage in that the connection work of the worker becomes easier.

The connection WORK may be applied to the connection structure of the example 2. In another example, the hook 11, 12 may be unnecessary. This is because the lifter and the lift each support their own weight.

Refer to FIG. 4(d). The connection body of two or more elevator modules connected to each other can be further lifted by at least one of the lifter and the lift. Preferably, the lifter can lift the connection body of the elevator modules.

Afterwards, the lifter can lift the connection body of the elevator module to a predetermined height and then return to the original position (a).

The present example may be an example in which the lifter T1 and the lift 8 operate together. The present example may be advantageously applied when the lifter has weak power. For example, the present example may be advantageously applied when the lifting power (power during the lifting operation) of the lifter is weak or non-existent, and the weight can be supported by the latch structure.

The present example may include embodiments in which the lifter is not applied. For example, the power and position control of the lift 8 may be possible. For example, after lifting one elevator module (first elevator module) by one floor using the lift, it may be disposed on a pre-installed stopper in the hoist way. The horizontal movement of the elevator may be performed by the position control of the lift and the provision of a stopper by the operator (interposing a bar between the lower end of the module and the hoist way wall). Thereafter, the lift may lift another elevator module (second elevator module). At this time, the first and second elevator modules may overlap each other in the vertical direction. This process may be repeated until all the elevator modules are lifted. The present embodiment may be preferably applied in cases where the building is low.

### EXAMPLE 4

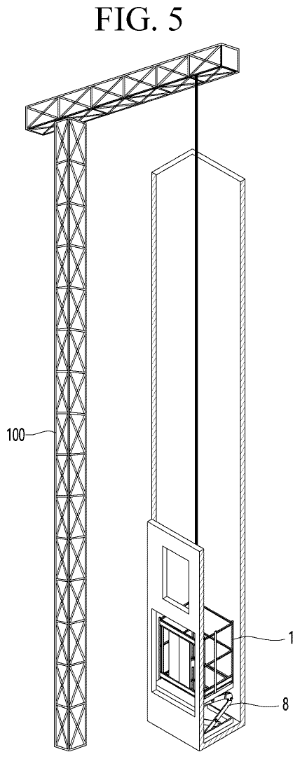

Example 4 is an example of lifting the elevator module in a building. The description of the present example is applicable to the description of example 3, and the differences are explained. FIG. 5 is a drawing illustrating a method for installing an elevator during the construction of a building.

Refer to FIG. 5. The opening 9, the lift 8 and the guide structure thereof may be provided in the same manner. In the present example, the method of supporting another elevator module (first elevator module) disposed on top of a currently introduced elevator module (second elevator module) is different. The first elevator module may be maintained in position by a crane 100. The first elevator module may not be a single module, but may be a connection body of the elevator module in which two or more elevator modules are connected.

Thereafter, in example 3, the work of the lifter T1 can be performed by the crane 100.

The present example can be advantageously applied when an elevator needs to be installed quickly during the first step of a building's construction (before finishing construction after the framework construction). For example, if the elevator is to be used during building construction, it can be installed quickly. This can be accomplished through the cooperation of the lift 8 and the crane 100.

### EXAMPLE5

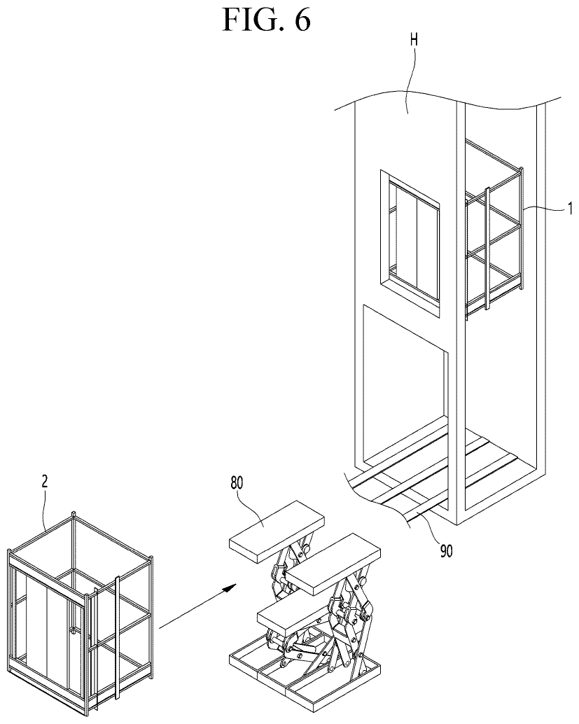

Example 5 is an example of lifting the elevator module in a building. The description of the present example is applicable to the description of the example 2, and the differences are explained. FIG. 6 is a drawing illustrating a method for installing an elevator during the construction of a building.

Refer to FIG. 6. The opening 9 may be provided in the same manner. As a device for lifting, at least two lifts 8 may be provided. Three lifts are illustrated in the drawing. The lifter and the crane may not be required. The lift may include a first lift adjacent to the center of the hoist way and a second lift adjacent to the edge of the hoist way. A rail 90 may be provided to guide the operation of the lift. For example, the second lift may move along the rail. The rail may extend in a direction orthogonal to the introduction direction of the elevator module. For example, when the introduction direction is the front and rear direction, the extension direction of the rail may be the left and right direction.

The operation of the lifts is described. When one elevator module (first elevator module) is introduced, both the first and second lifts can lift the one elevator module. After the module is lifted to a predetermined position, the first lift is lowered, and the second lift can support the weight of the elevator module.

Afterwards, another elevator module (second elevator module) may be introduced. At this time, the first lift may be lowered to the lower side of the second elevator module. At this time, the second lift may be disposed in a free space in the hoist way that does not obstruct the introduction of the second elevator module.

Thereafter, the first lift can lift the second elevator module. The lifting height of the first lift can be up to the height at which the first and second elevator modules are connected. At this time, the second lift can be disposed in a free space in the hoist way that does not interfere with the lifting of the second elevator module. Thereafter, the connection work of the first and second elevator modules can be performed. The connection work may be applied as described in the example 2.

While the connection work is being performed or after the connection, the second lift can move. For example, the second lift can perform the following actions: releasing the lifting load of the first elevator module (at this time, the first lift supports the connection body of the elevator module), moving outward (radially) of the hoist way along the rail 90, lowering the upper end of the lift, moving inward (central) of the hoist way along the rail 90, and raising the upper end of the lift to support the second elevator module. Thereafter, the first lift can release the lifting load of the second elevator module.

The process of introducing the first and second elevators and lifting the first and second lifts can be repeated. Through this, the lifting of all elevator modules can be completed.

The rail is provided to prevent the second lift from interfering with other components. Instead of the rail, the second lift may apply an extendable, rotating, or folding mechanism at the upper end portion. Accordingly, interference during the lifting load release, movement, and re-lifting of the second lift can be prevented.

### EXAMPLE 6

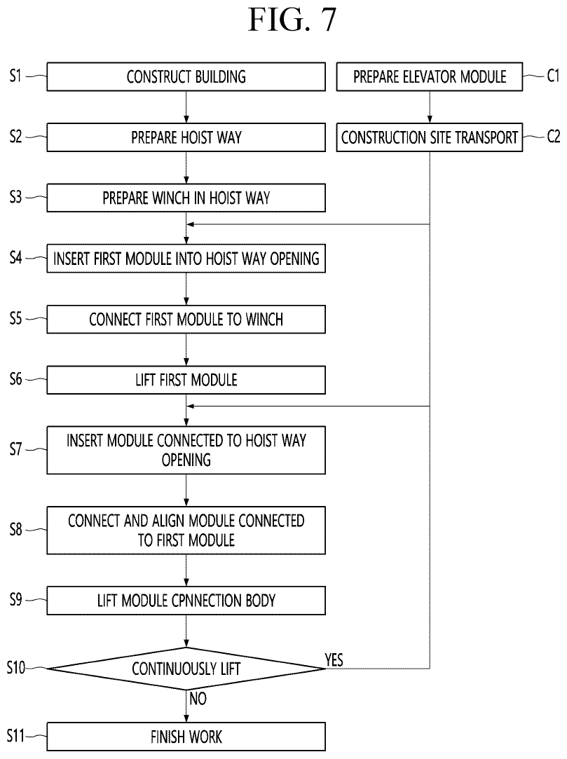

The present example is a flowchart detailing the construction method of a building according to the example 1. The construction method may include a method for installing an elevator. FIG. 7 is a flowchart illustrating a method for constructing a building.

Refer to FIG. 7. Building construction is performed (S1). During the building construction process, the hoist way may be prepared (S2). A lifter (for example, a winch) T1 may be prepared in the hoist way (S3). The lifter may be installed at the upper end portion of the hoist way.

The building may be constructed at a construction site where the building will be constructed. The elevator module may be prepared at an elevator production plant separate from the construction site (C1). As previously described, the prepared elevator module may have the necessary components for elevator operation fastened to the frame. The prepared elevator module may be transported to the construction site (C2).

A first elevator module among a plurality of elevator modules can be inserted into a hoist way through an opening 9 of the hoist way (S4). Connecting the first module to a lifter (S5) and lifting the first module by the lifter (S6) can be performed. By lifting the first module (S6), the hoist way aligned with the opening can be left empty. Thereafter, a second elevator module among a plurality of elevator modules can be inserted into the hoist way through the opening 9 of the hoist way (S7). The second module can be an elevator module that is continuous to the first module. Connecting the second module and the first module can be performed (S8). Here, the connection can include alignment between the modules. By connecting the first and second modules, a connection body of the elevator modules can be provided. During the connection, the alignment of the first and second modules can be controlled by the lifter. For example, the alignment can be performed by adjusting the height using the lifter and by the operator moving the position of the modules.

The lifter can lift the module connection body (S9). This process can be continued until all elevator modules required for elevator installation are lifted (S10). After lifting is complete, finishing work can be performed. The finishing work may include finishing construction of the building and a test run for elevator installation.

According to the present example, an opening 9 larger than the platform P can be provided during the construction phase. This large opening 9 can be provided for the installation of an elevator. In other words, changes may be made to the structural design and construction phase of the building for the installation of the elevator. Through such collaboration between the construction company and the elevator company, elevators can be provided more quickly, conveniently, and safely.

### EXAMPLE 7

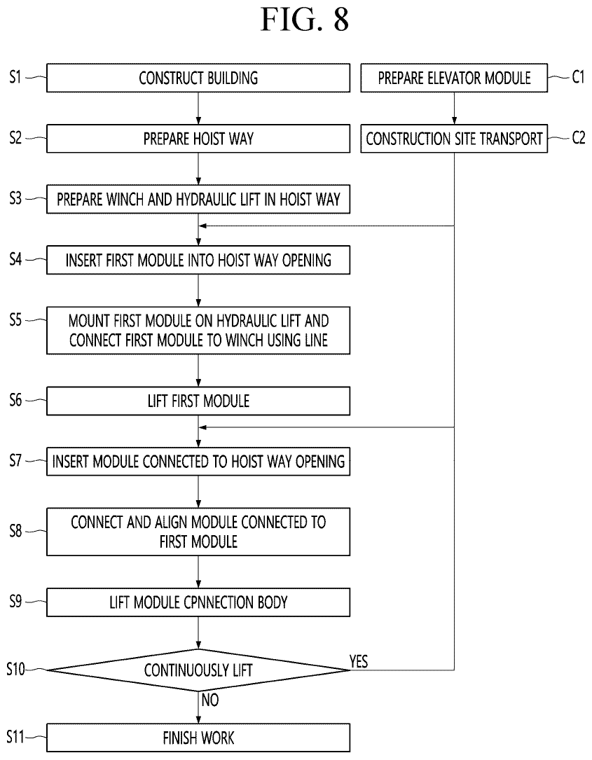

The present example is a flowchart detailing the first method for constructing a building according to example 3. The method for constructing a building may include a method for installing an elevator. The description of example 6 may be applied, and other portions will be described. FIG. 8 is a flowchart illustrating a method for constructing a building.

Refer to FIG. 8. A lifter T1 and a lift 8 can be prepared together in the hoist way H (S3). Thereafter, the introducing elevator modules can be mounted on the lift and hung on the lifter (S5). The lift and the lifter can lift the elevator modules, either cooperatively or independently. The lifting can be performed until all of the elevator modules are introduced.

The cooperation between the lift and the lifter may include a lifting operation of the lift, and the lifter withstanding a lifting load of the module connection body. The lifter withstanding the lifting load may be performed by engaging a latch. This may be referred to as a static load. The static load may be different from a moving load that the lifter performs a lifting operation. The cooperation between the lift and the lifter may include a lifting operation of the lift, a lifting operation of the lifter, and the lifter withstanding a lifting load of the module connection body.

The present example can be preferably applied when the building is tall.

### EXAMPLE 8

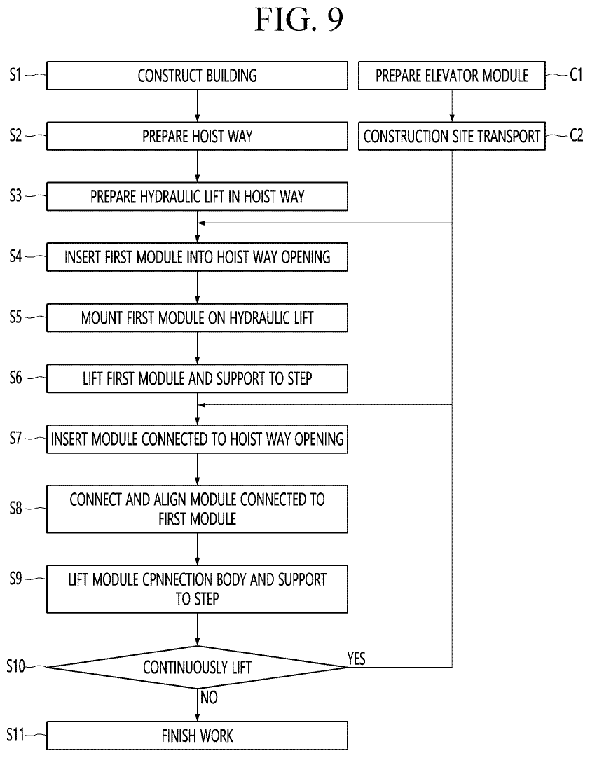

The present example is a flowchart detailing a second method for constructing a building according to example 3. The method for constructing a building may include a method for installing an elevator. The description of example 7 may be applied, and other portions will be described. FIG. 9 is a flowchart illustrating a method for constructing a building.

Refer to FIG. 9. A lift 8 can be prepared independently in the hoist way H (S3). Thereafter, the introducing elevator module can be mounted on the lift (S5). After the elevator module has been lifted a predetermined distance, the elevator module can be supported on the hoist way (S6). For example, the lifting load can be supported on a step provided in advance on the hoist way. Similarly, the module connection body can also be supported on the hoist way.

The present example can be preferably applied in cases where the height of a building is low.

### EXAMPLE 9

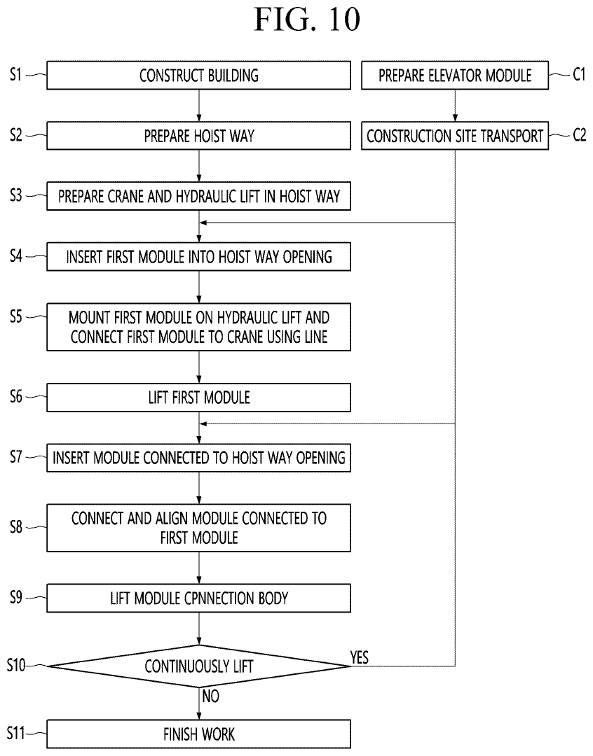

The present example is a flowchart detailing the method for constructing a building according to example 4. The method for constructing a building may include a method for installing an elevator. The description of example 7 may be applied, and other portions will be described. FIG. 10 is a flowchart illustrating the method for constructing a building.

Referring to FIG. 10, a crane 100 installed outside the hoist way can be applied to the lifter. Accordingly, the crane can lift more elevator modules. Since the crane is not installed in the hoist way H, the elevator can be constructed even before the hoist way is fully constructed.

The present example can be more preferably applied to high-rise buildings.

### EXAMPLE 10

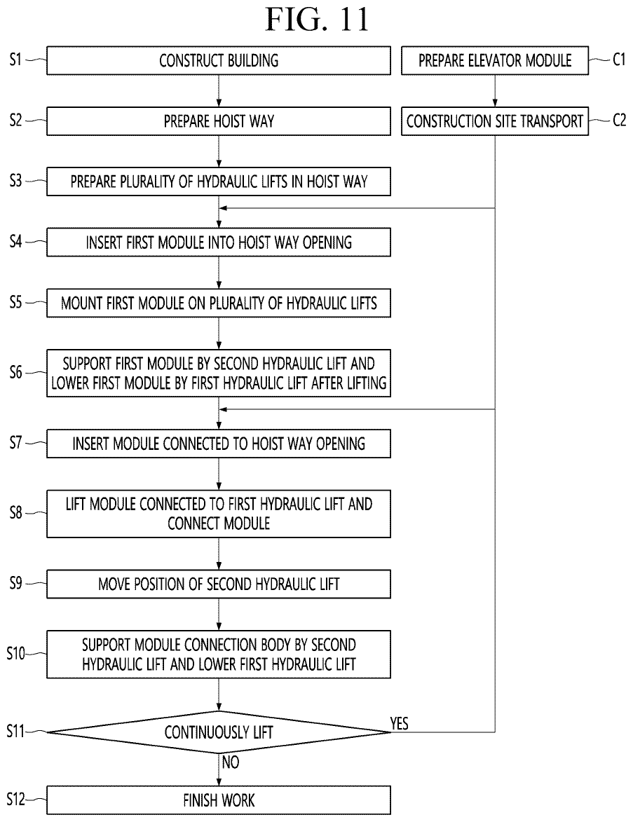

The present example is a flowchart detailing the method for constructing a building according to example 5. The method for constructing a building may include a method for installing an elevator. The description of example 6 may be applied, and other portions will be described. FIG. 11 is a flowchart illustrating the method for constructing a building.

Refer to FIG. 11. A plurality of lifts 8 may be prepared in the hoist way. Thereafter, when one elevator module (first elevator module) is introduced, the first and second lifts may lift the module (S5). After the module has been lifted to a predetermined position, the first lift may be lowered, and the second lift may support the weight of the elevator module (S6).

The first lift that has lowered can lift another elevator module (second elevator module) (elevator module that follows the first module), and the connection work of the first and second elevator modules can be performed (S8).

Since the first lift supports the connection body of the elevator module, the second lift can perform a first movement (S9). The first movement may include releasing the lifting load. The first movement may be a movement to prevent interference. Thereafter, the supporting operation of the connection body of the elevator module of the first lift and the second movement of the second lift can be performed (S10). The second movement may include a lowering operation and an raising operation of the second lift. Here, the lowering operation may include lowering below the lower end of the second elevator module. Here, the raising operation may include applying the lifting load of the second elevator module.

Before performing the second movement, the first movement may be performed in advance. Accordingly, the second lift may not interfere with surrounding components.

According to the present example, it can be preferably applied in cases where it is difficult to separately install a lifter in an intermediate-height building.

### INDUSTRIAL APPLICABILITY

The present disclosure may provide various advantages to elevators and buildings having such elevators.

What is claimed is:

1. A method for constructing a building, comprising:
providing a hoist way during building construction;
during the provision of the hoist way, providing an opening, at the lowest end of the hoist way, connecting the interior of the hoist way and the exterior of the hoist way;
lifting the first elevator module by a first length;
introducing a second elevator module stacked in the hoist way through the opening;
connecting the first elevator module and the second elevator module to provide a module connection body; and
lifting the module connection body by the first length.

2. The method for constructing a building of claim 1,
wherein at least one of the following is satisfied:
the opening is provided at a position slightly higher than a lowest end of the hoist way,
the opening is provided in the lowest platform at the lowest floor,
the opening is provided larger than the open space of the platform, and
the opening is provided larger than the cross-section of the elevator module in the vertical direction.

3. The method for constructing a building of claim 1,
wherein at least one of the following is satisfied:
before connecting the first elevator module and the second elevator module, the first elevator module is lowered by a second length, and the second length is shorter than the first length, and,
before connecting the first elevator module and the second elevator module, the second elevator module is lifted by a second length, and the second length is shorter than the first length.

4. The method for constructing a building of claim 1,
wherein after lifting the module connection body by the first length, introduction of another elevator module stacked in the hoist way through the opening and connection of the module connection body and the other elevator module to provide another module connection body are repeatedly performed.

5. The method for constructing a building of claim 1,
wherein at least one of the first elevator modules and the second elevator module is lifted by at least one of a lifter provided at the upper portion of the hoist way, a lift provided at the lowermost end of the hoist way, and a crane provided outside the building.

6. The method for constructing a building of claim 5,
wherein at least one of the following is satisfied:
at least one of the first elevator modules, the second elevator module, and the module connection body is lifted solely by the lifter;
at least one of the first elevator modules, the second elevator modules, and the module connection body is lifted solely by the lift;
at least one of the first elevator modules, the second elevator modules, and the module connection body is lifted by the lifter and the lift; and
at least one of the first elevator modules, the second elevator modules, and the module connection body is lifted by two or more lifts.

7. The method for constructing a building of claim 5,
wherein, in order to guide the lifting action of the lift, a movable plate provided on the upper portion of the lift, and a guide frame having a member extending in the vertical direction to guide the operation of the movable plate in the vertical direction and the operation of the elevator module in the vertical direction are provided.

8. The method for constructing a building of claim 1, further comprising:
a first hook provided on the first elevator module; and a second hook provided on the second elevator module and structured to be hooked onto the first hook;
wherein the first hook and the second hook are hooked to each other to connect the first elevator module and the second elevator module, and a worker can change the position of the second elevator module with respect to the first elevator module.

9. The method for constructing a building of claim 1, further comprising:
a first guide member provided to the first elevator module, and a second guide member provided to the second elevator module and fastened to the first guide member,
wherein, by providing an elongated hole extending in one direction in one of the first guide member and the second guide member, and providing a hole in the other of the first guide member and the second guide member, the first guide member and the second guide member are finally fastened after the first elevator module and the second elevator module are aligned after the temporary assembly.

10. The method for constructing a building of claim 1,
wherein after all necessary elevator modules have been introduced through the opening, in order to change the opening to the flatform, performing work reducing open size of the opening to a size and specification of the platform.

11. A method for installing an elevator, comprising:
assembling at least one module as an elevator component providing an elevator at a production site of the elevator;
providing an opening at the lowest end of a hoist way of the building during building construction, connecting the interior of the hoist way and the exterior of the hoist way;
transporting a first module among the at least one module stacked in the hoist way and introducing the first module through the opening;
lifting the first module and waiting for introduction of a new module;
introducing a second module among the at least one module stacked in the hoist way through the opening;
providing a module connection body by connecting the first module and the second module; and
lifting the module connection body.

12. The method for installing an elevator of claim 11,
wherein the module is a hexahedral frame provided with bars of predetermined cross-sections extending in the vertical direction, in the front and rear direction, and in the left and right direction, each of which is fastened to one another, and
wherein at least one of a rail, a door, and a buffer is assembled at the elevator production site in the frame.

13. The method for installing an elevator of claim 11, further comprising:
a first hook provided on the first module to connect the first module and the second module; and
a second hook provided on the second module and structured to be hooked onto the first hook.

14. The method for installing an elevator of claim 11, further comprising:
a first guide member provided to the first module; and a second guide member provided to the second module and fastened to the first guide member;
an unidirectionally elongated hole provided in one of the first guide member and the second guide member; a hole provided in the other of the first guide member and the second guide member; and a fastening member fastening the elongated hole and the hole to each other.

15. The method for installing an elevator of claim 14,
wherein the first guide member and the second guide member are provided at each of the four corners of the module, and
wherein the fastening member is finally fastened after the first guide member and the second guide member are temporarily assembled and the four corners are aligned.

16. The method for installing an elevator of claim 11,
wherein a lift installed in a space from a lower end of the opening to a lower end of the hoist way lifts the first module and the second module.

17. The method for installing an elevator of claim 16, wherein, together with the lift, a lifter or crane supports the first module and the second module.

18. The method for installing an elevator of claim 16,
wherein in a state where a plurality of lifts are provided, a first lift among the plurality of lifts is raised to support the first module, a second lift among the plurality of lifts is lowered to lift the second module.

19. A building provided by the methods of claim 1.

20. An elevator provided by the method of claim 11.
